(19) United States
(12) Patent Application Publication
(10) Pub. No.: US 2020/0033779 A1
(43) Pub. Date: Jan. 30, 2020

(54) FIXING DEVICE AND IMAGE FORMING APPARATUS

(71) Applicants: Takamasa HASE, Tokyo (JP); Yutaka NAKANO, Tokyo (JP); Hiroki TAKAHARA, Tokyo (JP)

(72) Inventors: Takamasa HASE, Tokyo (JP); Yutaka NAKANO, Tokyo (JP); Hiroki TAKAHARA, Tokyo (JP)

(73) Assignee: Ricoh Company, Ltd., Tokyo (JP)

(21) Appl. No.: 16/524,348

(22) Filed: Jul. 29, 2019

(30) Foreign Application Priority Data
Jul. 27, 2018 (JP) 2018-141379

(51) Int. Cl. G03G 15/20

(52) U.S. Cl. CPC G03G 15/2064; G03G 2215/2035; G03G 15/2053

(57) ABSTRACT

A fixing device includes a fixing member and a pressure member that comes into contact with the fixing member to form a nip. The fixing device conveys a recording medium carrying a not-fixed image to the nip and fixes the not-fixed image onto the recording medium. A vibration attenuation rate of the pressure member is set to 5% or higher, with respect to a maximum value of a frequency response function of the pressure member at 300 Hz or lower in a vibration test of the pressure member.

### CROSS-REFERENCE TO RELATED APPLICATIONS

The present application claims priority under 35 U.S.C. § 119 to Japanese Patent Application No. 2018-141379, filed on Jul. 27, 2018. The contents of which are incorporated herein by reference in their entirety.

### BACKGROUND OF THE INVENTION

### 1. Field of the Invention

The present invention relates to a fixing device and an image forming apparatus.

### 2. Description of the Related Art

Electrophotographic image forming apparatuses such as copiers and printers generally incorporate a fixing device that fixes an image onto a recording medium such as a sheet of paper.

Japanese Unexamined Patent Application Publication No. 2018-22124, for example, discloses a belt-type fixing device which includes an endless fixing belt, a pressure member that applies pressure to the outer circumference of the fixing belt, and a nip forming member that comes into contact with the pressure member via the fixing belt to form a fixing nip.

In such a fixing device, the fixing belt rotates in slide with the nip forming member, and frictional vibration occurs at the sliding location, which may cause abnormal noise. To deal with abnormal noise, Japanese Unexamined Patent Application Publication No. 2018-22124 proposes a method of reducing the abnormal noise due to the vibration by adding a vibration suppressing member between the nip forming member and a support member that supports the nip forming member.

To effectively reduce the vibration over a large area along the width of the belt by use of the vibration suppressing member, it is desirable for the vibration suppressing member to extend over the large area. However, the vibration suppressing member includes an elastic member, so that the vibration suppressing member extending over the large area may cause unstable positioning of the nip forming member with respect to the support member. In other words, with use of the vibration suppressing member, ensuring vibration suppression and stable positioning of the nip forming member have a trade-off relationship, i.e., exchange of one thing in return for another. With stable positioning of the nip forming member given priority, sufficient vibration effects may not be attained. Further, this method requires addition of the vibration suppressing member, which will lead to a design change for attachment of the vibration suppressing member.

### SUMMARY OF THE INVENTION

According to one aspect of the present invention, a fixing device includes a fixing member; and a pressure member that comes into contact with the fixing member to form a nip, the fixing device that conveys a recording medium carrying a not-fixed image to the nip and fixes the not-fixed image onto the recording medium. A vibration attenuation rate of the pressure member is set to 5% or higher, with respect to a maximum value of a frequency response function of the pressure member at 300 Hz or lower in a vibration test of the pressure member.

### BRIEF DESCRIPTION OF THE DRAWINGS

FIG. 1 is a schematic diagram of an image forming apparatus according to an embodiment of the present invention;

FIG. 2 is a schematic diagram of a fixing device;

FIG. 3 is a perspective view illustrating a support structure of a fixing belt;

FIG. 4 is a graph depicting a result of a frequency analysis of abnormal noise occurring from a conventional belt-type fixing device;

FIG. 5 is a chart depicting a frequency response function of vibration occurring in a pressure roller;

FIG. 6 is a chart depicting a frequency response function of vibration occurring in a stay;

FIG. 7 is a front view of a vibration measuring device used in a vibration test of a pressure roller alone;

FIG. 8 is a cross-sectional view taken at the line A-A in FIG. 7;

FIG. 9 is a cross-sectional view taken at the line B-B in FIG. 7;

FIG. 10 is a block diagram of a vibration measuring system used in a vibration test of the pressure roller alone;

FIG. 11 is a graph depicting a result of a frequency analysis of vibration occurring in the pressure roller in the vibration test of the pressure roller alone;

FIG. 12 is a graph depicting a result of a frequency analysis of vibration occurring in another pressure roller in a vibration test of the pressure roller alone; and

FIG. 13 is a schematic diagram of a fixing device that directly applies heat to a nip.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the accompanying drawings.

Throughout the drawings some constituent elements such as components and parts with the same functions or forms are denoted by the same reference numerals as long as they are mutually distinguishable, and the explanations thereof will be omitted.

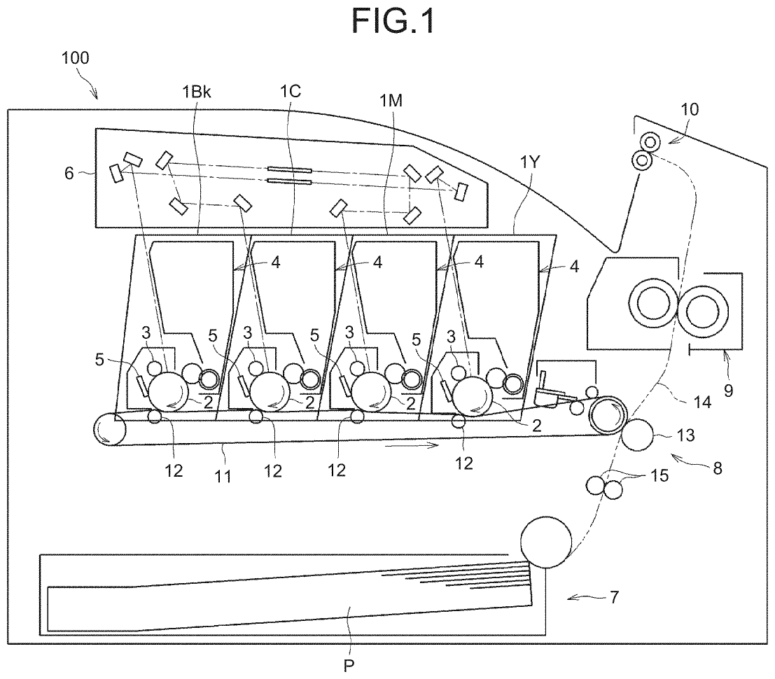

FIG. 1 is a schematic diagram of an image forming apparatus according to an embodiment of the present invention.

An image forming apparatus 100 illustrated in FIG. 1 includes four image formation units 1Y, 1M, 1C, and 1Bk that are attachable to and detachable from the main body of the image forming apparatus. The image formation units 1Y, 1M, 1C, and 1Bk have the same structure except for containing developing agents of different colors, namely, yellow, magenta, cyan, and black, corresponding to color-separated components of color images. More specifically, each of the image formation units 1Y, 1M, 1C, and 1Bk includes a drum photoconductor 2 serving as an image bearer; a charging device 3 that charges the surface of the photoconductor 2; a developing device 4 that forms a toner image by supplying toner serving as the developing agent to the surface of the photoconductor 2; and a cleaning device 5 that cleans the surface of the photoconductor 2.

The image forming apparatus 100 further includes an exposure device 6 that forms an electrostatic latent image by exposing the surface of each of the photoconductors 2 with light; a paper feeding device 7 that supplies a sheet of paper P serving as a recording medium; a transfer device 8 that transfers toner images from the photoconductors 2 onto the sheet of paper P; a fixing device 9 that fixes the toner images transferred on the sheet of paper P; and a paper ejection device 10 that ejects the sheet of paper P to the outside of the apparatus.

The transfer device 8 includes an endless intermediate transfer belt 11 that serves as an intermediate transfer member and extends over a plurality of rollers; four primary transfer rollers 12 serving as primary transfer members that transfer the toner images from the photoconductors 2 onto the intermediate transfer belt 11; and a secondary transfer roller 13 serving as a secondary transfer member that transfers the toner images from the intermediate transfer belt 11 onto the sheet of paper P. Each of the primary transfer rollers 12 is in contact with a corresponding one of the photoconductors 2 via the intermediate transfer belt 11. As a result, the intermediate transfer belt 11 is in contact with the respective photoconductors 2, forming primary transfer nips therebetween. Further, via the intermediate transfer belt 11, the secondary transfer roller 13 is in contact with one of the rollers around which the intermediate transfer belt 11 extends. This forms a secondary transfer nip between the secondary transfer roller 13 and the intermediate transfer belt 11.

The image forming apparatus 100 is provided with a paper conveyance path 14 inside through which the sheet of paper P from the paper feeding device 7 is conveyed. The image forming apparatus 100 includes a pair of timing rollers 15 in the middle of the paper conveyance path 14 between the paper feeding device 7 and the secondary transfer nip (the secondary transfer roller 13).

Next, a printing operation of the image forming apparatus will be explained with reference to FIG. 1.

In response to an instruction to start printing, in each of the image formation units 1Y, 1M, 1C, and 1Bk, the photoconductor 2 is rotated clockwise in FIG. 1, and the surface of the photoconductor 2 is uniformly charged by the charging device 3 to a high potential. Subsequently, on the basis of image information of an original document read by a document scanner or print information provided as a print instruction from a terminal device, the exposure device 6 exposes the surface of each of the photoconductors 2 with light and lowers the potential of the exposed part to form an electrostatic latent image. The electrostatic latent images are supplied with toner from the developing device 4 to form the toner image on the respective photoconductors 2.

The toner images formed on the photoconductors 2 reach the primary transfer nip (the position of the primary transfer roller 12) along with the rotation of the photoconductors 2 and are transferred onto the intermediate transfer belt 11 rotating counterclockwise in FIG. 1, on the top of each other. The toner images are then conveyed from the intermediate transfer belt 11 to the secondary transfer nip (the position of the secondary transfer roller 13) along with the rotation of the intermediate transfer belt 11. At the secondary transfer nip, the toner images are transferred onto the sheet of paper P supplied by the paper feeding device 7. The sheet of paper P supplied from the paper feeding device 7 is temporarily stopped by the timing rollers 15 and is then conveyed to the secondary transfer nip with appropriate timing at which the toner images on the intermediate transfer belt 11 arrives at the secondary transfer nip. Thus, a full-color toner image is carried on the sheet of paper P. After the transfer of the toner images, the cleaning devices 5 remove remaining toner from the photoconductors 2.

The sheet of paper P on which the toner image have been transferred is conveyed to the fixing device 9, so that the fixing device 9 fixes the toner image onto the sheet of paper P. After that, the sheet of paper P is ejected by the paper ejection device 10 to the outside of the apparatus, completing the series of printing operation.

Next, a structure of the fixing device 9 will be explained.

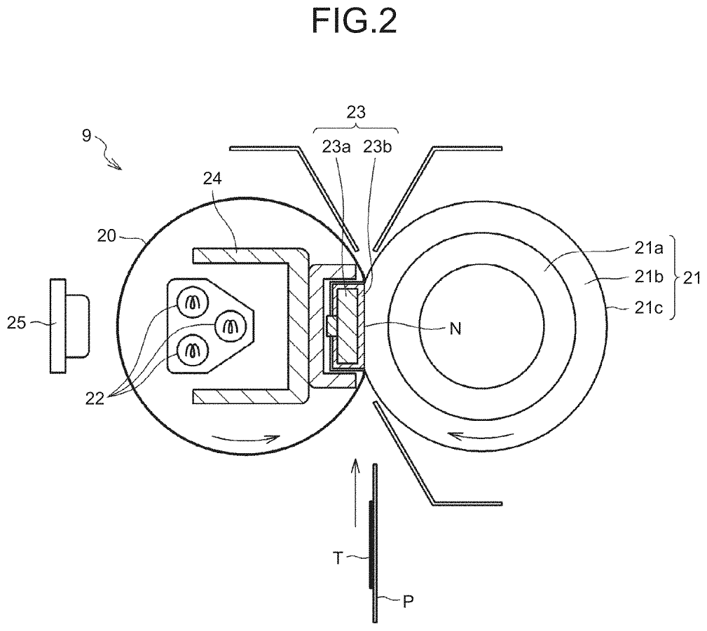

As illustrated in FIG. 2, the fixing device 9 according to the present embodiment includes an endless fixing belt 20 that serves as a fixing member; a pressure roller 21 serving as a pressure member or a pressure rotator that is applied with pressure against the fixing belt 20 to form a nip N between the pressure roller 21 and the fixing belt 20; a plurality of heaters 22 serving as heating means that apply heat to the fixing belt 20; a nip forming member 23 located on the inner circumference of the fixing belt 20; a stay 24 serving as a support member that supports the nip forming member 23; and a thermopile 25 serving as a temperature detector that detects temperature of the fixing belt 20.

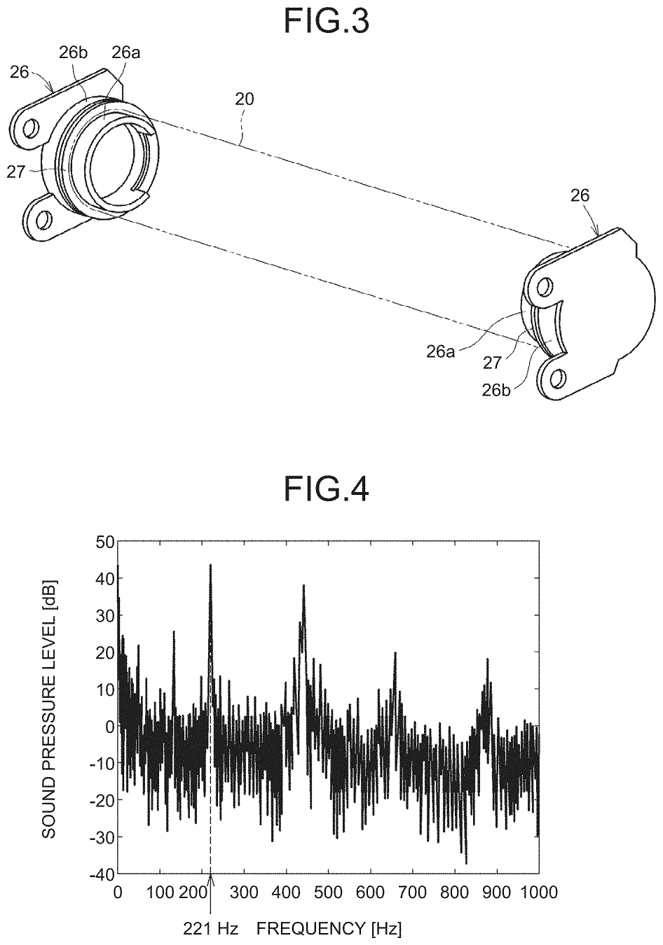

As illustrated in FIG. 3, the fixing belt 20 is rotatably supported at both ends by a pair of belt support members 26. Each of the belt support members 26 includes a belt support 26a of a substantially cylindrical shape or a C-shape. The outer diameter of the belt support 26a is smaller than the inner diameter of the fixing belt 20. The belt supports 26a are inserted into the inner circumference of the ends of the fixing belt 20, and both ends of the fixing belt 20 are thereby supported from the inner circumference. As explained herein, in the present embodiment, the fixing belt 20 is supported by the belt supports 26a having a smaller outer diameter than the inner diameter of the fixing belt 20, so that the fixing belt 20 is held in stationary state with basically no circumferential tension applied, that is, a free belt.

Further, as illustrated in FIG. 3, each of the belt support members 26 includes a belt regulator 26b being larger in outer diameter than the fixing belt 20. The belt regulators 26b function as parts that regulate axial movement of the fixing belt 20 when receiving an edging force in an axial direction. In the present embodiment, ring members 27 are placed between both end faces of the fixing belt 20 and the opposing belt regulators 26b. Each of the ring members 27 includes a slidable member. When an axial force is exerted on the fixing belt 20, the ring members 27 come into contact with the end faces of the fixing belt 20 to prevent the fixing belt 20 from being worn by friction. Further, the ring members 27 are rotatably attached to the outer circumference of the belt supports 26a so that, when the fixing belt 20 comes into contact with the ring members 27, the ring members 27 rotate together with the fixing belt 20, so as to be able to more effectively prevent the fixing belt 20 from being worn by friction.

The fixing belt 20 has a tubular base body made of stainless steel (SUS) having, for example, outer diameter of 30 mm and thickness of from 20 μm to 50 μm. The fixing belt 20 includes, as the outermost surface layer, a releasing layer made of fluorine-based resin such as PFA or PTFE and having thickness of from 5 μm to 30 μm, for the purpose of enhancing durability and ensuring releasability. The fixing belt 20 is provided with an elastic layer that is made of rubber of a thickness of from 50 μm to 300 μm, between the base body and the releasing layer, for example. The base body of the fixing belt 20 may be made of heat-resistant resin such as polyimide (PI) or may be a metal base body using nickel (Ni) in addition to stainless steel. As a sliding layer, the inner circumference of the fixing belt 20 may be coated with polyimide or PTFE.

As illustrated in FIG. 2, the pressure roller 21 has an outer diameter of 25 mm, for example, and includes a hollow cored bar 21a made of stainless steel, an elastic layer 21b on the surface of the cored bar 21a, and a releasing layer 21c on the outside of the elastic layer 21b. The elastic layer 21b is formed of silicone rubber and has a thickness of 3.5 mm, for example. To enhance releasability, it is desirable to form, on the surface of the elastic layer 21b, the releasing layer 21c made of a fluorine resin with a thickness of approximately 40 μm, for example.

The pressure roller 21 is biased toward the fixing belt 20 by a biasing means such as a spring. As a result, the pressure roller 21 is pressed against the nip forming member 23 via the fixing belt 20, forming the nip N between the fixing belt 20 and the pressure roller 21. Further, the pressure roller 21 is rotated by a driver. Along with the rotation of the pressure roller 21 in the direction indicated by the arrow in FIG. 2, the fixing belt 20 is rotated together.

The heaters 22 are arranged on the inner circumference of the fixing belt 20. The heaters 22 are configured to generate heat under the output control of a heating control unit provided in the apparatus body. The heating control unit performs the output control according to a result of sensing of the surface temperature of the fixing belt 20 from the thermopile 25. By the output control over the heaters 22, the temperature (fixing temperature) of the fixing belt 20 can be set to a desired temperature. As illustrated in FIG. 2, while the fixing belt 20 reaches the intended temperature, the sheet of paper P carrying a not-fixed toner image T is conveyed between the fixing belt 20 and the pressure roller 21 in rotation (the nip N). Thereby, the not-fixed toner image T is applied with heat and pressure and fixed onto the sheet of paper P. In the present embodiment, halogen heaters are used as the heaters 22; however, induction heating (IH) elements, resistor heat generating members, and carbon heaters may be used, for example, instead of the halogen heaters. The number of heaters 22 is not limited to three and may be changed as appropriate.

As illustrated in FIG. 2, the nip forming member 23 includes a longitudinal base pad 23a that continuously extends along the width of the fixing belt 20; and a sliding sheet (a low-friction sheet) 23b formed on the surface of the base pad 23a. Preferable examples of the material of the base pad 23a include polyether sulfone (PES), polyphenylenesulfide (PPS), a liquid crystal polymer (LCP), polyether nitrile (PEN), a polyamide-imide (PAI), and polyether ether ketone (PEEK), as heat-resistant materials being resistant to temperatures of 200° C. or higher. The nip forming member 23 made of such a material can prevent deformation of the base pad 23a caused by heat in the range of the toner fixing temperatures and can ensure stability of the nip N. The sliding sheet 23b may be placed on at least part of the surface of the base pad 23a that faces the fixing belt 20. Such a sliding sheet 23b works to reduce frictional resistance between the fixing belt 20 in rotation and the nip forming member 23. With the base pad 23a including a low-friction member, the nip forming member 23 may include the base pad 23a alone without the sliding sheet 23b. Further, the base pad 23a and/or the sliding sheet 23b may include a highly thermal conductive member.

The stay 24 is made of a metal material having high mechanical strength, such as stainless steel or iron. The stay 24 supports the nip forming member 23 (the base pad 23a). Thereby, the nip forming member 23 is prevented from bending against the pressure of the pressure roller 21, ensuring a uniform nip in the axial direction of the pressure roller 21.

In belt-type fixing devices in which a fixing belt is placed in-between a nip forming member and a pressure roller to form a nip, the fixing belt slides against the nip forming member while the fixing belt is rotating, which may cause frictional vibration at the sliding location. The frictional vibration may cause abnormal noise.

FIG. 4 is a graph depicting a result of a frequency analysis of abnormal noise occurring from a conventional belt-type fixing device.

As illustrated in FIG. 4, the sound pressure level of the abnormal noise exhibits the largest extreme value (maximum value) at the frequency of 221 Hz, for example. The vibratory force of the vibration occurs at the location of sliding between the inner circumference of the fixing belt and the nip forming member. However, fixing belts and nip forming members generally have small young's moduli, therefore, fixing belts and nip forming members are considered not to have natural vibration frequencies which take a maximum value at near 200 Hz. Thus, the abnormal noise is considered to occur as a result of amplified vibration of another component having such a natural vibration frequency value. Such a component other than the fixing belt and the nip forming member may be either the pressure roller or the stay supporting the nip forming member.

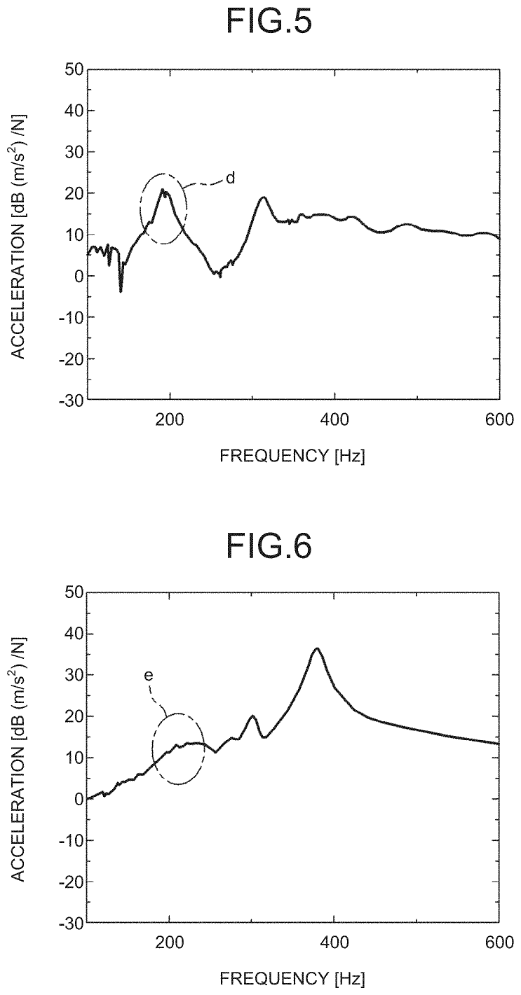

For this reason, a hammering test was conducted to find the natural frequency of the vibration of the pressure roller and the stay. FIGS. 5 and 6 present the results of the test.

FIG. 5 is a chart depicting a frequency response function of the vibration having occurred in the pressure roller. As illustrated in FIG. 5, it is confirmed from the frequency response function of the pressure roller that the acceleration (the vertical axis) indicating the magnitude of the natural vibration frequency exhibited a maximum value at or near the frequency of 200 Hz (the horizontal axis) (see the part indicated by the letter “d” in FIG. 5. In contrast, from FIG. 6 depicting a frequency response function of the vibration having occurred from the stay, the acceleration (the vertical axis) exhibited no maximum value at or near the frequency of 200 Hz (the horizontal axis) (see the part indicated by the letter “e” in FIG. 5). Consequently, it is assumed that the abnormal noise occur from the amplified vibration specific to the pressure roller.

However, the hammering test was conducted for the pressure roller and the stay assembled in the fixing device, therefore, the results of the measurement may be affected by other components. For this reason, another vibration test was conducted for the pressure roller alone so as to see whether the pressure roller has a natural vibration frequency that exhibits a maximum value near 200 Hz.

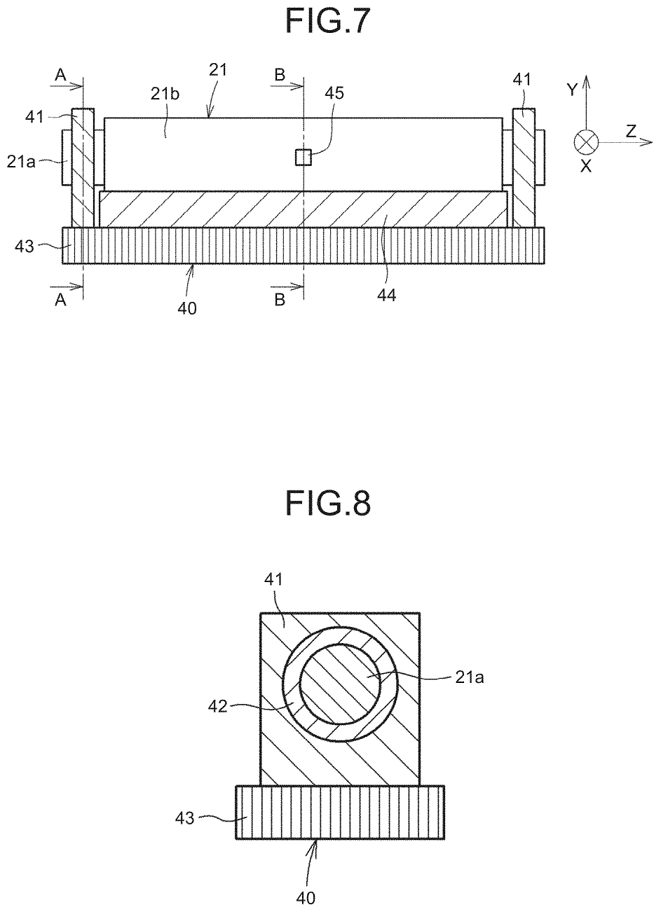

FIGS. 7 to 9 illustrate the structure of a vibration measuring device used in the vibration test of the pressure roller alone.

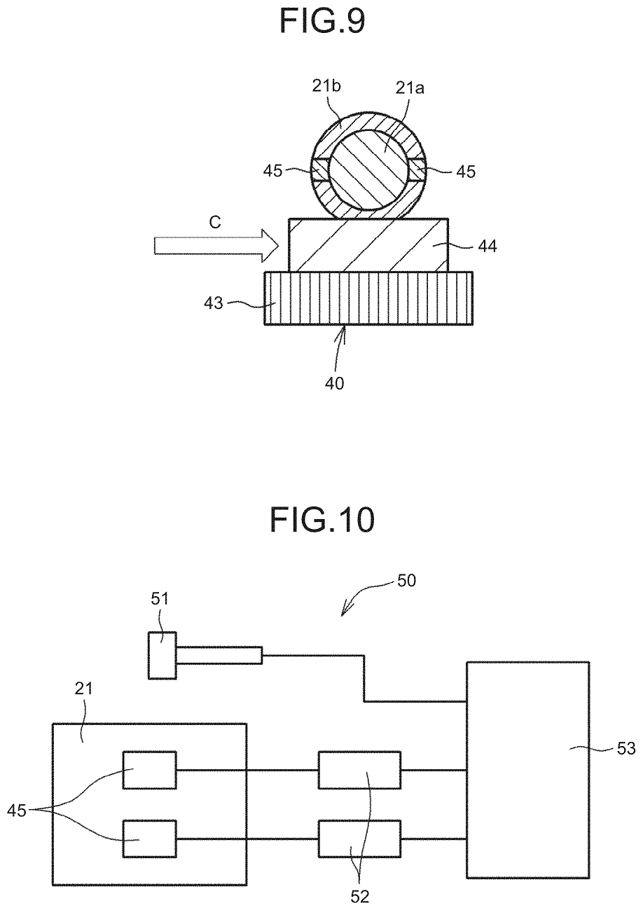

FIG. 7 is a front view of the vibration measuring device. FIG. 8 is a cross-sectional view taken at the line A-A in FIG. 7. FIG. 9 is a cross-sectional view taken at the line B-B in FIG. 7.

As illustrated in FIGS. 7 to 9, the vibration measuring device 40 includes a pair of lateral plates 41 that rotatably hold both ends of the cored bar 21a of the pressure roller 21 via ball bearings 42; a base 43 to which the pair of lateral plates 41 are fixed; and a pressure pad 44 located on the base 43 to apply pressure to the elastic layer 21b of the pressure roller 21. The lateral plates 41, the base 43, and the pressure pad 44 are made of a metal material having sufficient strength such as stainless steel, iron, or aluminum. In this example, the thickness of the pressure pad 44 is adjusted so that the surface pressure between the pressure pad 44 and the pressure roller 21 is to be in the range of 0.8 kgf/cm² to 1.5 kgf/cm². Further, part of the elastic layer 21b is removed from an axial center of the pressure roller 21 to expose the cored bar 21a, an acceleration sensor 45 is adhered to the surface of the exposed cored bar 21a (in two locations) with an adhesive. The acceleration sensor 45 is capable of measuring three-dimensional vibration in mutually orthogonal X-, Y-, and Z-directions in FIG. 7.

FIG. 10 is a block diagram of a vibration measuring system used in the vibration test of the pressure roller alone.

As illustrated in FIG. 10, a vibration measuring system 50 includes an impact hammer 51 (086C01 manufactured by PCB Piezotronics, Inc.) serving as a vibration means for applying vibration to the pressure roller 21 as a subject of measurement; a charge converter 52 (CH-6130 manufactured by Ono Sokki Co., Ltd.) that converts an acceleration signal or a charge signal from the acceleration sensor 45 (NP-2506 manufactured by Ono Sokki Co., Ltd.) attached to the pressure roller 21 into a voltage signal; and an FFT analyzer 53 (DS-3000 manufactured by Ono Sokki Co., Ltd.) that analyzes vibration from the resultant signal through the charge converter and outputs a frequency response function thereof. The information as a result of the analysis by the FFT analyzer 53 may be input to a computer, for example.

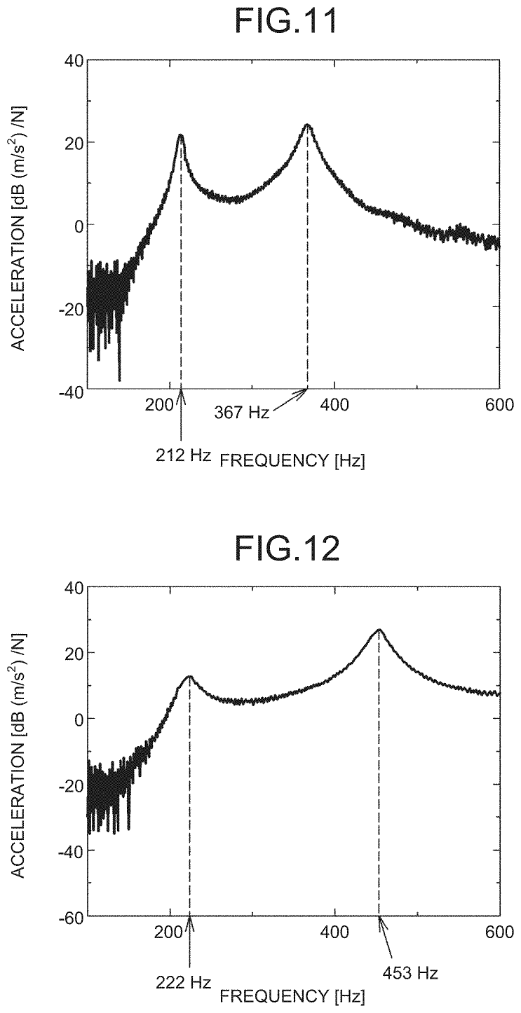

In the vibration test of the pressure roller alone, while the pressure roller 21 is placed on the vibration measuring device 40, vibration was applied to the pressure roller by applying an impact to the pressure pad 44 with the impact hammer 51 in the direction indicated by arrow C in FIG. 9. Herein, the direction of the impact applied to the pressure pad 44 was set to the direction indicated by arrow C, since the direction of arrow C corresponds to the direction of the shear force received by the pressure roller from the nip forming member during actual operation. The vibration in the direction of arrow C occurring in the pressure roller 21 in this situation was analyzed by the vibration measuring system 50, and a frequency response function thereof was found. FIG. 11 presents result of the analysis.

As illustrated in FIG. 11, from the result of the vibration test of the pressure roller alone, it is confirmed that the frequency response function exhibited maximum values in two locations, i.e., at the frequencies of 212 Hz and 367 Hz and that the frequency response function exhibited a maximum value near 200 Hz, which is considered to cause the abnormal noise. Of the maximum values in the two locations, the vibration mode corresponding to the maximum value at 212 Hz is, in particular, a vibration mode in the rotational direction of the pressure roller and is considered to be likely to occur during actual operation (while the pressure roller is rotating). In contrast, the vibration mode corresponding to the maximum value at 367 Hz is a vibration mode from torsion and flexure of the shaft of the pressure roller, which is unlikely to occur during actual operation and thus considered not to cause the abnormal noise.

Further, the vibration test was also conducted in a similar manner for another pressure roller (hereinafter, “pressure roller β”) different from the above pressure roller. This pressure roller differs in roller hardness and thickness of an elastic layer from the pressure roller (hereinafter “pressure roller α”) used in the previous test. FIG. 12 presents the test result.

As illustrated in FIG. 12, in the vibration test of the pressure roller β alone, the frequency response function exhibited maximum values in two locations, at the frequencies of 222 Hz and 453 Hz. As compared with the test result of the pressure roller α illustrated in FIG. 11, in the vicinity of 200 Hz, which is considered to cause the abnormal noise, the frequency response function exhibits a relatively sharp form at the extreme value (at the frequency of 212 Hz) in FIG. 11, while the frequency response function exhibits a relatively gradual form at the extreme value (at the frequency of 222 Hz) in FIG. 12.

To check the occurrence of abnormal noise due to the difference, the two pressure rollers α and β were attached to fixing devices and were heated and rotated for twenty minutes with a linear velocity of 80 mm/sec or higher at the temperature of 180° C., and then the linear velocity was lowered to 20 mm/sec. As a result of this, abnormal noise occurred from the pressure roller α under a specific condition, whereas no abnormal noise occurred from the pressure roller β under the same condition.

Thus, to find out the cause of the occurrence or non-occurrence of the abnormal noise from the pressure rollers α and β, the frequency response function of the pressure roller α at 212 Hz and the frequency response function of the pressure roller β at 222 Hz were further analyzed by vibration analyzing software, “ME′scope VES” (manufactured by Vibrant Technology, Inc.). By this vibration analyzing software, it is possible to find a natural vibration frequency and a vibration attenuation rate by plugging a second-order lag transfer function to a transfer function obtained from the test (curve fit).

The result of the analysis is such that the vibration attenuation rate of the pressure roller α was 1.78%, whereas the vibration attenuation rate of the pressure roller β was 5.5%. Thus, it is found that the abnormal noise occurred from the pressure roller α having a lower vibration attenuation rate whereas no abnormal noise occurred from the pressure roller β having a higher vibration attenuation rate.

To study in detail the relationship between the vibration attenuation rates of the pressure rollers and the occurrence or non-occurrence of the abnormal noise, a plurality of pressure rollers with mutually different vibration attenuation rates were prepared to see whether or not abnormal noise occurs. The following Table 1 presents the results.

TABLE 1

| | Vibration | | | Elastic | | |
|---|---|---|---|---|---|---|
| | Attenua- | | Roller | Layer | | |
| | tion Rate | Roller | Diameter | Thickness | Abnormal | Dura- |
| | [%] | Hardness | [mm] | [mm] | noise | bility |
| Example 1 | 5.5 | 45 | 32 | 4 | No | Good |
| Example 2 | 8 | 40 | 35 | 5 | No | Good |
| Example 3 | 11 | 35 | 35 | 6 | No | Fair |
| Compari- | 4.0 | 50 | 32 | 4 | Yes | Good |
| son 1 | | | | | | |

Table 1 lists roller hardness (ASKER-C hardness), roller diameter, thickness of elastic layer, occurrence or non-occurrence of abnormal noise, and durability, in addition to the vibration attenuation rates of the pressure rollers. In Table 1, the vibration attenuation rates of the pressure rollers in Example 1, Example 2, Example 3, and Comparison 1 are 5.5%, 8%, 11%, and 4.0%, respectively. According to the results in Table 1, no abnormal noise occurred in Examples 1, 2, and 3, whereas abnormal noise occurred in Comparison 1. In other words, it can be said that at the vibration attenuation rate being 5% or higher as in Examples 1, 2, and 3, no abnormal noise occurs, and that at the vibration attenuation rate being lower than 5%, abnormal noise occurs as in Comparison 1. Thus, it is possible to prevent the occurrence of the abnormal noise by setting the vibration attenuation rate of the pressure roller to 5% or higher.

Further, in terms of the durability in Table 1, Examples 1 and 2 are preferable among Examples 1, 2, and 3. Examples 1 and 2 excel in durability over Example 3 due to a larger roller hardness and a thinner elastic layer. In terms of durability relative to vibration attenuation rate, the vibration attenuation rate is preferably 10% or lower, as in Examples 1 and 2. In other words, as seen from the relationship in Examples 1, 2, and 3 in Table 1, the lower the roller hardness is, the higher the vibration attenuation rate is; and the thicker the elastic layer is, the higher the vibration attenuation rate is. That is, in order to enhance durability, it is desirable to avoid higher vibration attenuation rate (to be maintained at 10% or lower), and set a higher roller hardness and a thinner thickness of the elastic layer.

As explained above, by setting the vibration attenuation rate of the pressure roller to 5% or higher, it is possible to suppress the vibration of the pressure roller, which may cause abnormal noise. Thus, in belt-type fixing devices such as the fixing device according to the embodiment in which frictional vibration may occur at the sliding location between the fixing belt and the nip forming member, it is possible to prevent the occurrence of the abnormal noise by setting the vibration attenuation rate of the pressure roller to 5% or higher.

Generally, such abnormal noise often occurs in the frequency band of approximately 100 Hz to 300 Hz inclusive. The vibration attenuation rate of the pressure roller may be set to 5% or higher, with the frequency response function of the pressure roller having a maximum value at 300 Hz or lower in the vibration test. Further, the abnormal noise cannot be clearly heard in the frequency band of 50 Hz or lower, so that the vibration attenuation rate of the pressure roller may be set to 5% or higher with respect to a maximum value at from 50 Hz to 300 Hz inclusive. To sufficiently enhance the durability of the pressure roller, the vibration attenuation rate of the pressure roller is preferably set in the range from 5% to 10% inclusive.

As described above, according to the embodiment, it is possible to prevent the occurrence of the abnormal noise by simply setting the vibration attenuation rate of the pressure roller to the certain value, without an additional vibration suppressing member such as the one described in Japanese Unexamined Patent Application Publication No. 2018-22124. Thus, with no design change due to addition of the vibration suppressing member and no significant design change, the abnormal noise can be easily prevented. Further, without such a vibration suppressing member affecting the stability in positioning the nip forming member, it is therefore possible to attain the vibration suppressing effects over a large or the whole area of the pressure roller in the axial direction while ensuring the stable positioning of the nip forming member. Furthermore, the vibration attenuation rate of a pressure roller does not significantly fluctuate over time, so that the abnormal-noise preventing effect is sustainable for a long period of time.

Certain embodiments of the present invention have been explained above; however, various modifications or changes can be made to the embodiments without departing from the scope of the present invention.

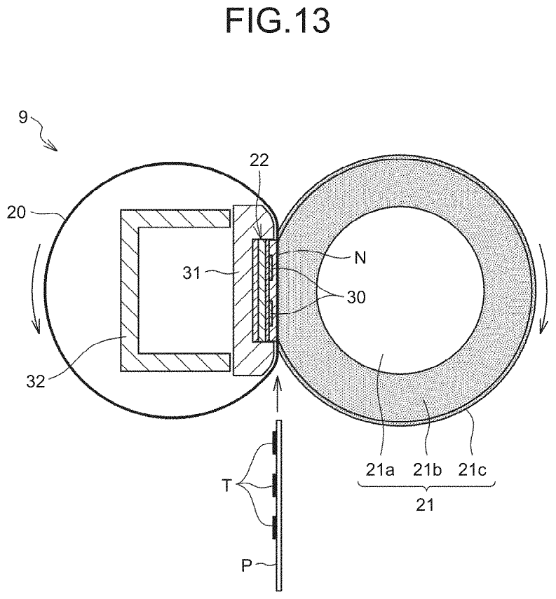

For example, the present invention is applicable not only to the fixing device illustrated in FIG. 2 in which the fixing belt 20 except for the nip N is directly heated by the heaters 22, but also to a fixing device illustrated in FIG. 13 including the heater 22 directly heating the nip N of the fixing belt 20. The heater 22 illustrated in FIG. 13 is a plane heater that includes a resistance heating element 30 and is in contact with the inner circumference of the fixing belt 20 at the nip N. More specifically, the heater 22 is supported by a holder 31 serving as a holding member to hold the heater 22 and by a stay 32 serving as a support member to support the holder 31. The pressure roller 21 comes into contact (is pressured) with (against) the thus-supported heater 22 via the fixing belt 20, thereby forming the nip N between the fixing belt 20 and the pressure roller 21. In such a fixing device 9, the rotation of the fixing belt 20 in slide with the fixed, non-rotating heater 22 may cause abnormal noise and frictional vibration at the sliding location. Thus, in such a fixing device 9, by setting the vibration attenuation rate of the pressure roller to 5% or higher with the frequency response function of the pressure roller having a maximum value at or lower than 300 Hz in the vibration test, as explained above, it is made possible to suppress the vibration of the pressure roller which may cause the abnormal noise and to thereby prevent the occurrence of the abnormal noise. That is, the present invention is applicable to any structure as long as a fixing member slides with a non-rotating fixed member such as a nip forming member or a heater, to be able to prevent the abnormal noise, which would be otherwise caused by the vibratory force occurring at the sliding location.

According to the embodiment of the present invention, without an additional vibration suppressing member, it is possible to effectively prevent the occurrence of the abnormal noise by simply setting the vibration attenuation rate of the pressure member to 5% or higher, with respect to the maximum value of the frequency response function of the pressure member at 300 Hz or lower in the vibration test.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

What is claimed is:

1. A fixing device comprising:
a fixing member; and
a pressure member that comes into contact with the fixing member to form a nip, the fixing device that conveys a recording medium carrying a not-fixed image to the nip and fixes the not-fixed image onto the recording medium, wherein
a vibration attenuation rate of the pressure member is set to 5% or higher, with respect to a maximum value of a frequency response function of the pressure member at 300 Hz or lower in a vibration test of the pressure member.

2. The fixing device according to claim 1, wherein
the vibration attenuation rate of the pressure member is set to 5% or higher, with respect to the maximum value of the frequency response function of the pressure member at from 50 Hz to 300 Hz inclusive in the vibration test.

3. The fixing device according to claim 1, wherein
the vibration attenuation rate of the pressure member is set to from 5% to 10% inclusive.

4. The fixing device according to claim 1, further comprising:
a heater that heats the fixing member, wherein
the heater heats part of the fixing member other than the nip.

5. The fixing device according to claim 1, further comprising:
a heater for heating the fixing member, wherein
the heater heats the nip of the fixing member.

6. The fixing device according to claim 1, wherein
the fixing member includes an endless fixing belt that is rotatable, and
the pressure member includes a pressure rotator that forms the nip between the pressure member and the fixing belt by contacting, via the fixing belt, with a nip forming member placed on an inner circumference of the fixing belt.

7. The fixing device according to claim 6, wherein
the nip forming member includes a highly thermal conductive member.

8. An image forming apparatus comprising the fixing device according to claim 1.
